(19) United States
(12) Patent Application Publication
(10) Pub. No.: US 2004/0024716 A1
(43) Pub. Date: Feb. 5, 2004

(54) Mail sorting processes and systems

(76) Inventors: James Malatesta, Hockessin, DE (US); Edward Cohen, Mt. Laurel, NJ (US)

Correspondence Address: SCHNADER HARRISON SEGAL & LEWIS, LLP, 1600 MARKET STREET, SUITE 3600, PHILADELPHIA, PA, 19103

(21) Appl. No.: 10/412,454

(22) Filed: Apr. 11, 2003

Related U.S. Application Data
(60) Provisional application No. 60/371,979, filed on Apr. 12, 2002.

(51) Int. Cl. G06F 17/00; G07B 17/02

(52) U.S. Cl. 705/410; 705/406

(57) ABSTRACT

A method of sorting items using multiple OCR attempts. A marking is read on the item with use of at least two or more of the following: a first algorithm with second settings; a second algorithm; and the first algorithm with second settings. The marking readings are compared to a database, and if the marking corresponds to data in the database, the data is selected. Readings may be performed simultaneously or consecutively. Also disclosed is a computer readable medium and system of one or more computers, and computer data signals embodied in a transmission medium to carry out the inventive methods, and a sorting system that carries out methods of the resent invention.

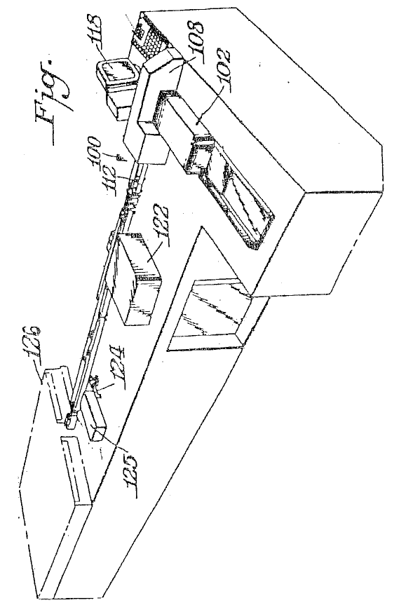

This application is based on, and claims priority to, provisional application having serial No. 60/371,979 having a filing date of Apr. 12, 2002, and entitled Mail Sorting Processes and Systems.

### FIELD OF THE INVENTION

The invention relates to sorting processes, such as may be applied to documents of different sizes and types.

### BACKGROUND OF THE INVENTION

Definitions will first be provided for a better understanding of the background of the invention, and the invention itself.

DPBC—Delivery Point Bar Code. This is also called an 11-digit ZIP Code. It identifies a delivery point for mail. The DPBC is currently the highest level of sortation in the United States. Every delivery point (i.e., each mailbox) has a unique DPBC.

Default DPBC—A DPBC that is generated when an exact DPBC cannot be determined. Usually some portion of the digits can be determined. For instance, if nine digits can be determined (which typically describes a block on one side of the street), an 11-digit default DPBC is given (e.g., 14215-1324-99). In default DPBC, usually, the unknown digits are filled with ‘9’. Sometimes a 5-digit default DPBC is given (e.g., 14215-9999-99). Usually this defines a P.O. Box ZIP Code where the box number is unknown or out of the specified range.

Flats—Flats are large mail pieces (typically magazine-sized). The United States Postal Service (USPS) has precise definitions of flats; however, there are some gray areas. Typically, a flat is a mail piece (which can be an envelope or a magazine) that is greater than 9 inches long, greater than 5 inches high and less than 0.75 inches thick.

OCR—Optical Character Recognition. This is reading an image, for example, converting a picture into characters. While in an ideal world the OCR produces characters corresponding to their actual values (i.e., reads correctly), OCR on mail processing machines produces characters which may contain some errors.

OCR Engine—The program that performs an OCR algorithm.

Lookup—Lookup is converting OCR results to an answer, which for mail processing typically a ZIP Code or a DPBC. This process typically involves using the OCR results and comparing those results to USPS databases to determine a correct answer. However, it could also involve using OCR results and comparing them to an internal database, such as a list of factory employees, to determine the destination for incoming mail.

Processing Time—This is the amount of time available on computers to perform algorithms. A system needs to get an answer in a certain time interval after the image is captured and before any printing or sorting is performed. Processing time is the time available on computers. Processing time can be increased by increasing the computer speed or the number of computers available. There is a tradeoff between increased processing-time, which can give better performance, and reduced processing time, which can save money. The goal in general is to perform the most useful algorithms in whatever processing time is available. Therefore, anything that accomplishes the same task in less processing time will save money by minimizing needed computer resources and/or improving performance by letting other algorithms run in the freed up computers. Manufacturers can usually add more processing time by adding extra computers to improve performance such as read rates.

Document sorting typically includes scanning an item with an optical character reader to read an image, then converting the results to an answer. In the context of mail sorting, the answer may be, for example a ZIP Code. Answers are generated by performing a lookup process which includes comparing the OCR results to one or more data bases. It is desirable to shorten the sorting process to achieve greater throughput. Sorting can be slowed down if sorting information on an item is difficult to locate. For example, an address on a mail item may only occupy a small portion of the total item, and locating the address will take time. Additionally, extra makings may interfere with the address recognition process. OCR performance can be diminished if there is not optimum binarization. Traditionally systems use a single binarization level that may not be optimum for all items being sorted.

Differences in characters to be recognized may also slow the sorting time. For example, some items may contain machine printing whereas others may contain hand printing. A single OCR engine may require considerable time to differentiate and process the two types of printing.

Furthermore, OCR results may create a plurality of answers. A need exists for efficiently processing the choices to elect the best answer.

Accordingly, there is a need for methods to reduce sorting process times.

### SUMMARY OF THE INVENTION

Embodiments of the invention include a method of sorting items using multiple OCR attempts. A marking is read on the item with use of at least two or more of the following: a first algorithm with first settings; a second algorithm; and the first algorithm with second settings. The marking readings are compared to a database, and if the marking corresponds to data in the database, the data is selected. Readings may be performed simultaneously or consecutively.

An additional embodiment of the invention is a sorting method based on location of identifying markings.

A further embodiment of the invention includes efficiently sorting items by recognizing that they are a batch of similar or identical type items, i.e. are batch items.

Yet another embodiment of the invention uses recognizing known orientations of items.

Also disclosed is a computer readable medium and system of one or more computers, and computer data signals embodied in a transmission medium to carry out the inventive methods.

A Sorting system is also presented that carries out methods of the present invention.

### DESCRIPTION OF THE DRAWING

The invention is best understood from the following detailed description when read with the accompanying drawings.

The figure depicts a sorting apparatus according to an illustrative embodiment of the invention.

### DETAILED DESCRIPTION OF THE INVENTION

Following is a description of document sorting processes according to illustrative embodiments of the invention. For illustration purposes, the processes are first described as they relate to mail item sorting.

### Address Location

Address location involves taking an image and locating a region of interest that contains the address, and hopefully only the address, i.e., not extra text or markings.

With additional processing time, multiple attempts at address location can be made. Several address candidates can be sent to the OCR system. The reason multiple candidates may be useful is that address location is not always correct. While addresses are normally correctly located for well-formed addresses, unusual situations may make determining the location of the address, prior to reading text, difficult. For instance, some addresses have “Pay To:” written near the address. This text should be excluded from the address if possible. In another instance, a ZIP Code or advertising text may be far to the right of the address. It may be desirable to process the address with and without the extra text, since until the OCR is performed, the system does not know if the extra text should be included in the address.

After the address is located, a rectangle or other defined region can be used to define its location. The rectangle can be expanded to include text that is on the lower right corner from the rectangle. For instance, some addresses are printed with ZIP Codes, and/or state names, that have a large gap between the ZIP Code or state name and the state name or city name. In these instances, most of the address text, such as name, street address, and city name, is in a smaller rectangle, but key information, such as ZIP Code or state name, is to the lower far right. Many address block location algorithms will locate the main address area; however, an extra search step is required for the text to the far right. Therefore, in an exemplary embodiment of the invention, algorithms first locate the main address area. Then, a search is made to the lower right looking for character-sized text. The search area can be user defined, so that the area can be widened for ZIP Codes with an extra wide gap and the area can be narrowed for addresses that have non-address text, such as advertising, to the right of the address.

A further embodiment of address location is also presented. POSTNET codes are included in many mail pieces. The POSTNET codes are either applied afterward in the “clear area location” at a mailer or are included in the address block. In the second case, when the printer prints the address, the POSTNET code is in the address, either as the top-most line, the 2nd line from the top, or the bottom-most line The address can be located by using the POSTNET code as an indicator. The reasons for this

are that locating POSTNET codes is easier than locating addresses because POSTNET codes have a more regular structure and a check digit. Even if the entire postnet code cannot be read, its approximate location can usually be determined, such as by reading a portion of the POSTNET code. If one looks at a mail piece and finds a POSTNET code that is not in the “clear area location”, that POSTNET code is very likely in the address. If an address POSTNET location is known, this can help determine the location of the address. For instance, the address is very near the POSTNET code and is in the same orientation (horizontal or vertical). So, one can locate an address POSTNET code and look at a predefined distance from it, such as just above it just beneath it, or both, to locate the address. In addition, the address and the address POSTNET code are usually oriented in the same direction. That is, if the address POSTNET code is horizontal, the address can be oriented left-to-right or right-to-left. If the address POSTNET is oriented left-to-right, the address is also located left-to-right approximately 90% of the time.

### Binarization.

Binarization is converting a gray-scale image, captured from a camera, for example, to a black and white image, which is required by most OCR engines. Selecting a binarization level means selecting how dark or light the image is, similar to the darkness selection on a copier machine.

In an illustrative embodiment of the invention, the system automatically determines the best binarization level. The best binarization level is determined by repeatedly binarizing the gray image and measuring how much the resulting image has an expected texture of character-sized blobs.

Since small changes in a binarized image can affect the OCR performance, an exemplary embodiment of the invention includes binarizing at different levels. That is, even though the system decides on an optimal binarization level, the system binarizes slightly darker or slightly lighter also. Those images are also passed to the OCR engine. Sometimes, the slight changes in the binarized image allow a successful OCR read result.

Sometimes the algorithm used to choose the best binarization level does not choose correctly. This can occur for some very small fonts, some very light characters, or some characters with unusual properties, i.e., tall thin characters. If a customer is running a collection of mail pieces that all have similar fonts that the automatic binarizer does not process well, an embodiment of the invention allows the user to specify a binarization level. Then, each piece is binarized at the user-selected level. In addition, the system may binarize slightly darker or slightly lighter also. The reason is that even though a customer has manually selected a good binarization level, the OCR may give better results for slightly different binarization levels.

### Hand-print (Including Cursive) vs. Machine-print Discrimination.

A group of mail items may contain both machine-print and hand-print items. To process both types the system may have machine-print and hand-print recognition engines. It is desirable to send machine-print pieces to the machine-print OCR engine and hand-print pieces to the hand-print OCR engines.

In an illustrative embodiment of the invention, a discriminator determines whether each piece is hand-print or machine-print. The discriminator works by locating an address and taking measurements of the address elements. For instance, machine-print characters usually have a much more uniform height and thickness than hand-print characters. Also, the spacing between lines is more uniform. If a located address block has an address with uniform line spacing and uniform characters size and thickness, the address is determined to be machine-print; otherwise, the address is determined to be hand-print. In one embodiment of the invention, if no address block is located, the address is determined to be hand-print.

### Additional Processing Dot-matrix.

Some fonts are printed using a dot-matrix method. Dot-matrix printing is usually an older printing method that uses coarsely spaced dots. To print a character, each dot location is turned on or off to give a likeness of the character. Dot-matrix print quality is often lower quality than methods such a laser printing.

Some OCR engines are not designed to recognize dot-matrix style printing. Therefore, in an embodiment of the invention, the dots are merged together to make the characters resemble non-dot-matrix printing. By filling in spaces between nearby black areas of an image, the image appears smeared which can improve OCR read rates for dot-matrix characters on certain OCR engines.

An illustrative embodiment of the invention lets the user select the mode dot-matrix or non-dot-matrix. If the dot-matrix mode is selected, the image is smeared before being passed to the OCR engine. Otherwise, no smearing is performed. A system may also recognize dot-matrix printing and automatically select the dot-matrix mode.

If sufficient processing time is available, a smeared and non-smeared image can be passed to the OCR engine.

### Multiple OCR Attempts.

If sufficient processing time is available, multiple OCR attempts can be made, using different OCR engines, or different settings of the same OCR engine. If the results of any attempt are sufficient to allow a Lookup to be determined, that result is used and any other results can be ignored.

### Multiple Lookup Attempts.

A lookup attempt is performed when OCR results are used to try to determine an answer, e.g., a USPS ZIP Code or DPBC.

Since OCR results can sometimes produce multiple choices for each character, the method of organizing OCR results for a lookup attempt is not always clearly defined. Since different organizations of OCR results can return different results, e.g., ZIP Code or DPBC, it is useful to have multiple lookup attempts in the same manner that multiple OCR attempts are useful. The following is an example of different OCR organizations. Suppose a character is recognized as a 0 (zero), O (capital letter O), and D (capital letter d). To organize the character results for a lookup attempt, the system must decide which character result (0, O, or D) is the most likely and how likely the other choices are. For instance, one lookup attempt could be made with the zero as the most likely result for that character and another OCR attempt could be made with a D as the most likely result. Given that each address has an average of about 40 characters and each character can have several choices, it: is likely that a large number of OCR organizations are possible for each address.

### Choosing Best Candidate.

When multiple attempts are made, sometimes multiple possible answers are returned. For instance, if multiple processors are working on an address, they may both return valid results. In these cases, the system needs to determine if any of the answers is correct. If one result returns a 5-digit ZIP Code and another result returns an 11-digit ZIP Code, the 11-digit answer is taken. If multiple 11-digit answers are available and only one of the answers has a non-default DPBC, the non-default answer is selected. For instance, if one ZIP Code results is 08054-2356-15 (a non-default answer) and the other result is 08054-2356-99 (a default answer), the non-default answer is selected. If multiple non-default answers are available, the highest confidence one may be selected e.g., the one with the most likely binarization level, or if three answers are available and two agree. If no choice is obviously correct, all are rejected to avoid making an erroneous assignment.

### Processing in Batch Mode.

In many locations, pieces are run in a batch. That is, mail from a particular customer is run consecutively. Mail from the same batch is likely to have very similar features. For instance, all mail may be the same size, have the same font, the style of printing, and the same general address location, or some subset of these.

If the system is likely to have similar pieces run together, the system can process a piece in a manner that was successful for a previous piece. For instance, suppose a piece is run and is recognized. The settings, e.g. address block location, successful binarization setting, successful OCR engine, etc., for that piece can be temporarily or permanently stored. When the next piece is processed, the system may want to use the previous pieces successful settings as the first recognition attempt. If the first recognition attempt is not successful, other automatic recognition attempts can be used. This method would allow the system to adaptively choose the most successful approaches to be tried on each piece. This can save processing time and improve the read rate.

Sometimes mail is not run in a batch mode. One quick and simple test is to measure the piece length and height. These measurements are normally done for each piece for address block location purposes. If the measurements of a piece match a previous piece, the two pieces may be from the same batch. If the measurements do not match, the pieces are not likely to be from the same batch. Using this technique, the system can actively and automatically determine whether mail is in batch mode.

The above method can be extended by keeping track of several pieces, for example five. If all successfully processed pieces have similar settings, the system can assume that it is in batch mode. If the pieces do not have similar settings, the system assumes it is not in batch mode. Keeping track of read settings uses minimal extra processing time. Therefore, the system will only go into batch mode when it is likely to be an actual batch. This is important because going into batch mode when, pieces are not from the same batch will degrade performance as inappropriate settings may be used on a piece.

### Flats Processing.

### Address location for Flats (Where Address Orientation is Unknown).

For large non-oriented mail pieces, such as flats, that are captured at high resolution, time may still be critical issue. An orientation mark can be placed on the mail piece to quickly determine the orientation. For instance, if a barcode is placed in the upper right corner of the mail piece, relative to the destination address, locating the barcode will determine the orientation. Locating an address on a piece of known orientation is much faster and more accurate than locating an address on a piece of unknown orientation.

### Additional Flats Processing in Batch Mode.

The batch settings can be additionally useful in flats mail where the orientation of the mail is unknown. In batch mode, the mail is likely to be run in such a way that all addresses are oriented in the same direction.

In some flats mail operations, additional marks, such as barcodes, are read on each piece. In those operations, the marks are often located in the same position on each piece when the mail is run in a batch mode. By using the batch mode strategy, the search for additional marks can be focused near the location of the last successful read. This approach can reduce processing time, since flats mail is large and require large high-resolution images to read them. Searching for regions of interest, such as addresses or additional marks, is often the most time consuming portion of the process. For instance, if the additional marks will always be in one corner of the mail piece. If mail is run in a batch mode and a fixed search strategy is used to locate the additional marks, the system may have to try the three incorrect corners before the correct corner is processed. By using the adaptive batch mode strategy, the system begins processing the correct corner first on all remaining pieces, after the first few pieces of the batch are correctly processed. This can reduce the processing requirements to 25% of the worst case situation.

For large non-oriented flats that are captured at high resolution, time is still a critical issue. Average processing time can be reduced if most of the mail is processed in a batch mode. In a batch mode, most of the mail in a batch is run in the same orientation. In addition, the address may be located in a similar location. If the computer records the orientation and/or address block location of a successfully read piece, that information is useful for processing the next piece. If the system assumes that the next piece is oriented in the same manner as the previous piece, a quick check on orientation, e.g., looking for an orientation marker, can be made instead of analyzing all orientations. In addition, if the orientation matches up well, the location of the address can be narrowed to reduce processing time. If height and width is measured first, that measurement can be used to determine if the next piece is likely to be in batch mode.

The processes above can be applied to sorting of any type of document or item that can be sorted by capturing images and analyzing the captured images. Although the processes have been described with respect to mail sorting, one skilled in the art will understand that they may be applied to other types of documents and items. For example, address location determination processes can be applied to locate any particular information location on a document, such as invoice numbers, customer numbers, etc. Other concepts described above that can be applied to documents other than mail items include, for example, binarization, hand-print/machine-print processing, dot-matrix processing, multiple OCR or lookup attempts, choosing best results, batch mode strategies and picture orientation concepts.

The invention will now be described in its more general embodiments that may be applied to sorting items in addition to mail. Embodiments of the invention may be used alone or in conjunction with one another.

Items may be sorted by using multiple lookup attempts. A marking on an item is first read. The marking is compared to data in a database using two or more result organizations. Data in the database most closely resembling the marking is selected. Database comparisons may be performed simultaneously, consecutively or a combination thereof.

Multiple OCR attempts may also be used either in conjunction with multiple lookup attempts or not. A marking on the item is read with use of at least two or more of the following: a first algorithm with first settings; a second algorithm; and the first algorithm with second settings. The marking readings are compared to a database. If the marking corresponds to data in the database, that data is selected. Readings may be performed simultaneously, consecutively or a combination thereof.

Binarization may be used to enhance recognition. An expected character texture is designated. An image of a marking is binarized and compared to the expected character texture. If the binarized image is within a predefined range of the expected character image, that binarized image is selected. If the binarized image is not within a predefined range of the expected character image, binarization is performed at a different level. The binarizing may be repeated until the image is within a predefined range of the expected character image or until a predefined number of binarizations has been executed, which ever comes first. After the image is within a predefined range of the expected character image, it may be binarized at different levels. The binarization level may be user specified or automatic.

Embodiments of the invention may process images based on whether markings are hand printing or machine printing, or differ by some other identifiable characteristic. A marking is located on the item. One or more elements of the marking are measured or otherwise identified by its characteristics. The marking type is identified based on the element characteristics such as measurements. The marking types may be for example, machine-printed and handwritten markings. In an exemplary embodiment of the invention, if no marking is located, the item is identified as containing hand-printing.

Embodiments of the invention may account for dot-matrix printing, and may increase recognition of dot matrix printing or other markings made up of a plurality of sub-markings. The sub-markings are merged, and then identified. Whether a system is in a mode that merges sub-markings or one that does not merge sub-markings can be selected by the user or implemented automatically based on the system's ability to recognize whether sub-marking are present. Either a merged image, or both a merged and non-merged image may be sent to an optical character reader.

Processing time may be reduced by efficiently locating a particular marking on an item such as an address. A first marking is located on an item. The location of the marking is then defined with a first area on the item. The item is then searched in a predefined second area to locate a second marking. The search is preferably based on the first area location, first marking orientation or combination thereof. The item is then sorted according to, at least in part, the first marking, second marking or a combination thereof. Sorting the item may include reading an image of a marking, comparing the read image to a database, and selecting data from the database that most closely resembles the read image.

Recognizing that items are in batch mode may significantly reduce processing time. A first item is imaged and interpreted, thereby producing settings. The settings produced from the first item are stored, at least in part. The stored first item settings are used for an initial attempt to process a second item. In an exemplary embodiment of the invention, the settings include dimension measurements of at least a portion of the item. One or more additional items may be imaged and interpreted, thereby producing settings for those additional items. When a selected number of items produce the same settings, the process for the additional items may be performed using the same settings. The settings for any of the additional items not matching to a selected degree the settings produced from the first item may be stored and used for attempts to process subsequently imaged items.

Embodiments of the invention may also facilitate sorting by recognizing the orientation of an item. A marking is sensed on a first item to determine an item orientation based on a known configuration. The first item is imaged and interpreted using settings based on the item orientation. The items are sorted based on information obtained from the image. This method may further include locating a first marking on the item and defining the location of the marking with a first area on the item. The item is searched in a predefined second area to locate a second marking. The search is preferably based on the first area location, first marking orientation or combination thereof. The item is then sorted according to, at least in part, the first marking, second marking or a combination thereof. At least a portion of the settings produced from imaging and interpreting the first item may be stored, and used for an initial attempt to process a subsequent item. In an illustrative embodiment of the invention, the settings stored include the location of the marking.

Embodiments of the invention further include a document sorting system comprising a computer readable medium to carry out any of the processes described herein and apparatus to sort the documents categorized by programs or programs stored either permanently or temporarily on the computer readable medium. The figure depicts an illustrative sorting apparatus 100. Computer 118 embodies software to carry out one or more processes of the invention, for example, a program to perform multiple OCR attempts on a plurality of items. In a further embodiment, the program has machine-print and hand-print recognition engines.

Items 102 are fed into sorting apparatus 100. Feeder 108 feeds the items into the system. Optical character reader 122 reads an image on an item while the item is transported by transport system 112. In the illustrative embodiment of the figure a printer 124 and reader 125 are positioned to mark and read the item. This may be for example, a bar code printer and bar code reader for mail. Items are then sorted in sorting section 126, which typically includes a series of diverters that divert items into receptacles based on sorting information obtained by one or more methods of the invention.

Further illustrations of some possible sorting apparatus components are described in one or more of the following U.S. Pat. Nos. 5,398,922, 5,544,758, 5,226,547 and 5,521,365. Other sorting structure may be used to sort items processed by the methods described herein. The sorting apparatus structure will be primarily based on the type of item to be sorted.

Also included in embodiments of the invention are computer readable media programmed to carry out any of the processes described herein, and one or more computers to carry out such processes.

Still further included in embodiments of the invention are computer data signals embodied in a transmission medium to carry out processes described herein.

While the invention has been described by illustrative embodiments, additional advantages and modifications will occur to those skilled in the art. Therefore, the invention in its broader aspects is not limited to specific details shown and described herein. Modifications, for example, to the types of items, algorithms used and configurations of sorting systems may be made without departing from the spirit and scope of the invention. Accordingly, it is intended that the invention not be limited to the specific illustrative embodiments, but be interpreted within the full spirit and scope of the appended claims and their equivalents.

Claimed is:

1. A method of sorting items comprising:
reading a marking on the item with use of at least two or more of the following: a first algorithm with first settings; a second algorithm; and the first algorithm with second settings;
comparing the marking readings to a database; and
if the marking corresponds to data in the database, selecting the data.

2. The method of claim 1 wherein two or more of the readings are performed simultaneously.

3. The method of claim 1 wherein two or more of the readings are performed consecutively.

4. The method of claim 1 further comprising:
designating an expected character texture;
binarizing an image of the marking and comparing it to the expected character texture;
if the binarized image is within a predefined range of the expected character image, selecting that binarized image;
if the binarized image is not within a predefined range of the expected character image, binarizing at a different level;
repeating the binarizing until the image is within a predefined range of the expected character image or until a predefined number of binarizations has been executed, which ever comes first.

5. The method of claim 4 further comprising:
after the image is within a predefined range of the expected character image, binarizing at different levels.

6. The method of claim 4 wherein a user specifies a binarization level.

7. The method of claim 1 further comprising;
locating the marking on the item;
identifying characteristics of one or more elements of the marking; and
identifying the marking type based on the characteristics.

8. The method of claim 7 wherein the identifying characteristics are element measurements.

9. The method of claim 7 wherein the marking types include machine-printed and handwritten.

10. The method of claim 8 wherein if no marking is located, identifying the item as containing hand-printing.

11. The method of claim 1 wherein the marking has a plurality of sub-markings, the method comprising:
merging the sub-markings; and
identifying the markings.

12. The method of claim 11 further comprising:
selecting between a mode that merges sub-markings and a mode that does not merge sub-markings.

13. The method of claim 11 further comprising:
sending a merged and a non-merged image to an optical character reader.

14. A method of sorting items comprising:
locating a first marking on the item;
defining the location of the marking with a first area on the item;
searching the item in a predefined second area to locate a second marking, wherein the search is based on the first area location, first marking orientation or combination thereof; and
sorting the item according to, at least in part, the first marking, second marking or a combination thereof.

15. The method of claim 14 wherein sorting the item includes:
reading an image of a marking;
comparing the read image to a database; and
selecting data from the database that most closely resembles the read image.

16. A method of sorting items comprising:
imaging and interpreting a first item, thereby producing settings;
storing at least part of the settings produced from the first item; and
using the stored first item settings for an initial attempt to process a second item.

17. The method of claim 16 wherein the settings include dimension measurements of at least a portion of the item.

18. The method of claim 16 further comprising;
imaging and interpreting one or more additional items, thereby producing settings for the one or more additional items; and
when a selected number of items produce the same settings, running the process for additional items using the same settings.

19. The method of claim 16 further comprising:
imaging and interpreting one or more additional items, thereby producing settings for the one or more additional items;
storing the settings for any of the one or more additional items not matching to a selected degree the settings produced from the first item; and
using the stored settings for attempts to process subsequently imaged items.

20. A method of sorting items comprising:
sensing a marking on a first item to determine an item orientation based on a known configuration;
imaging and interpreting the first item using settings based on the item orientation; and
sorting the item based on information obtained from the image.

21. The-method of claim 20 further comprising:
locating a first marking on the item;
defining the location of the marking with a first area on the item;
searching the item in a predefined second area to locate a second marking, wherein the search is based on the first area location, first marking orientation or combination thereof; and
sorting the item according to, at least in part, the first marking, second marking or a combination thereof.

22. The method of claim 20 further comprising:
storing at least a portion of the settings produced from imaging and interpreting the first item; and
using the stored first item settings for an initial attempt to process a subsequent item.

23. The method of claim 22 wherein the settings stored include the location of the marking.

24. The method of claim 20 further comprising:
producing settings from the first item image;
storing at least part of the settings produced from the first item;
using the stored first item settings for an initial attempt to process a second item.

25. The method of claim 24 wherein the settings includes dimension measurements of at least a portion of the item.

26. The method of claim 24 further comprising;
storing settings produced from one or more additional items;
when a selected number of items produce the same settings, running the process for additional items using the settings.

27. The method of claim 24 further comprising:
imaging and interpreting one or more additional items, thereby producing settings for the one or more additional items;
storing the settings for any of the one or more additional items not matching to a selected degree the settings produced from the first item; and
using the stored settings for attempts to process further items.

28. A computer readable medium to carry out the method of claim 1.

29. A computer readable medium to carry out the method of claim 14.

30. A computer readable medium to carry out the method of claim 16.

31. A computer readable medium to carry out the method of claim 20.

32. A system comprising one or more computers to carry out the method of claim 1.

33. A system comprising one or more computers to carry out the method of claim 14.

34. A system comprising one or more computers to carry out the method of claim 16.

35. A system comprising one or more computers to carry out the method of claim 20.

36. A computer data signals embodied in a transmission medium to carry out the method of claim 1.

37. A computer data signals embodied in a transmission medium to carry out the method of claim 14.

38. Computer data signals embodied in a transmission medium to carry out the method of claim 16.

39. Computer data signals embodied in a transmission medium to carry out the method of claim 20.

40. A method of sorting items comprising:
locating an address POSTNET code on a mail item;
using the POSTNET location to search, within a defined distance from the POSTNET code, for an address in an orientation the same as that of the POSTNET code based on the address having known characteristics.

41. The method of claim 40 wherein the predefined distance is in the range of about 0.75 inches to about 1.25 inches.

42. A method of sorting items comprising:
reading a marking on an item;
comparing the marking reading to data in a database using two or more result organizations; and
selecting data in the database most closely resembling the marking.

43. The method of claim 42 wherein the two or more database comparisons are performed simultaneously.

44. The method of claim 43 wherein the two or more database comparisons are performed consecutively.
